(19) United States
(12) Patent Application Publication
(10) Pub. No.: US 2022/0395877 A1
(43) Pub. Date: Dec. 15, 2022

(54) WASTE VOLUME-REDUCTION PROCESSING METHOD AND WASTE VOLUME-REDUCTION PROCESSING SYSTEM

(71) Applicant: OHGI TECHNOLOGICAL CREATION CO., LTD., Otsu-shi, Shiga (JP)

(72) Inventors: Takehiko OHGI, Otsu-shi, Shiga (JP); Tatsuhiko OHGI, Otsu-shi, Shiga (JP)

(21) Appl. No.: 17/776,497

(22) PCT Filed: Nov. 14, 2019
(86) PCT No.: PCT/JP2019/044668

§ 371 Date: May 12, 2022

(51) Int. Cl. B09B 3/40; B09B 3/35; B09B 3/80

(52) U.S. Cl. CPC B09B 3/40; B09B 3/35; B09B 3/80; B09B 2101/77

(57) ABSTRACT

A waste volume reduction processing method includes a volume reduction step of reducing volume of waste in a volume reduction furnace in which temperature is raised in stages multiple times, the waste being a mixture of organic waste containing plastic and inorganic waste containing metal material, the volume reduction step including a first volume reduction step of storing and heating the waste in the volume reduction furnace in which temperature is raised up to around 200° C. to be kept, the volume reduction furnace being sealed in an oxygen-free state or in a low-oxygen state, the organic waste being reduced in volume to 20% to 30% of original volume.

### TECHNICAL FIELD

The disclosure relates to a waste volume reduction processing method and a waste volume reduction processing system in which waste is reduced in volume by being heated in a volume reduction furnace in an oxygen-free or low-oxygen state.

### BACKGROUND ART

Conventionally, various methods have been proposed to reduce the volume of organic waste by heating waste in an oxygen-free or low-oxygen state, such as a volume reduction method by thermal decomposition, for example referring to Patent Documents 1 and 2. According to the method, organic waste is further reused by carbonization compared with the incineration (combustion) of waste. In addition, thermal decomposition does not generate flame and is less likely to produce toxic substances such as dioxins.

### CITATION LIST

### Patent Literature

Patent Literature 1: Japanese Patent Application Publication No. 2019-5741

Patent Literature 2: Japanese Patent Application Publication No. 2007-246867

### SUMMARY OF INVENTION

### Technical Problem

Some organic waste contains chlorine, toxic gases such as dioxins may be produced when such waste is thermally decomposed, and it is necessary to detoxify toxic gases separately.

Further, even in the case of thermal decomposition, depending on the heating temperature, some resin material in organic waste may melt without being carbonized, although gas is generated, and therefore some organic waste has low reuse rate.

The present invention is proposed in view of the above-mentioned problems and has an object to provide a waste volume reduction processing method and a waste volume reduction processing system capable of suppressing the generation of harmful substances such as dioxins when waste is heated in an oxygen-free or low-oxygen state and capable of increasing the reuse rate of organic waste in the waste.

### Solution to Problem

In order to achieve the above-mentioned object, in a waste volume reduction processing method including a volume reduction step of reducing the volume of waste in a volume reduction furnace in which temperature is raised in stages multiple times, the waste is a mixture of organic waste containing plastic and inorganic waste containing metal material, the volume reduction step includes a first volume reduction step of storing and heating the waste in the volume reduction furnace in which temperature is raised up to around 200° C., the volume reduction furnace being sealed in an oxygen-free state or in a low-oxygen state, and the organic waste is reduced in volume to 20% to 30% of the original volume.

In order to achieve the above-mentioned object, a waste volume reduction processing system includes a volume reduction device in which the volume of waste is reduced in an oxygen-free state or in a low-oxygen state at 200° C., and then the waste is selectively reduced in volume at 350 to 400° C., the waste being a mixture of organic material containing plastic and inorganic material containing metal material. The waste volume reduction processing system also includes a metal separating device to extract residual metal material.

### Advantageous Effects of Invention

Since the waste volume reduction processing method of the present invention includes the procedures mentioned above, the generation of harmful substances such as dioxins is suppressed when the waste is heated in an oxygen-free or low-oxygen state, and the reusability of the organic waste in the waste is improved.

Further, since the waste volume reduction processing system of the present invention is configured as described above, the same effect as the waste volume reduction processing method is expected. Then, further volume reduction and extraction of the residual metal material after volume reduction processing are facilitated.

### BRIEF DESCRIPTION OF DRAWINGS

FIG. 1 is a flow diagram (1/2) illustrating the basic procedure of the waste volume reduction processing method (system) according to the first embodiment of the present invention.

FIG. 2 is a flow diagram (2/2) of the same.

FIG. 3 is a graph explaining the control temperature in a volume reduction step.

FIG. 4 is a schematic diagram of a volume reduction device for use in the waste volume reduction processing method according to the embodiment.

FIG. 5 is a conceptual diagram of a ranking step in the waste volume reduction processing method according to the second embodiment of the present invention.

FIG. 6 is a flow diagram (1/2) illustrating the basic procedure of the waste volume reduction processing method (system) according to the second embodiment.

FIG. 7 is a flow diagram (2/2) of the same.

FIG. 8 is a table with actual photographs respectively showing classified organic waste after each step, the volume of the classified organic waste being reduced.

### DESCRIPTION OF EMBODIMENTS

Embodiments of the present invention are described with reference to the accompanying drawings.

First, the flow of a basic procedure of a volume reduction processing method of waste (hereinafter, simply referred to as a volume reduction processing method) and the basic configuration of a volume reduction processing system of waste (hereinafter, referred to as a volume reduction processing system) are described.

This volume reduction processing method includes a volume reduction step in which the volume of waste 3 is reduced by raising the temperature in stages multiple times in a volume reduction furnace. The waste 3 is a mixture of organic waste containing plastic and inorganic waste containing metal material.

The volume reduction step includes the first volume reduction step in which the waste 3 is stored and heated in the volume reduction furnace that is heated to and maintained at around 200° C. and is sealed in an oxygen free or low-oxygen state, and the organic waste is reduced to 20 to 30% of the original total volume.

Further, the volume reduction processing system includes a volume reduction device 20 and a metal separating device 30 for extracting residual metal material. In the volume reduction device 20, the volume of the mixture of organic waste containing plastic and inorganic waste containing metal material is reduced in an oxygen-free or low-oxygen state at around 200° C., and then the volume is selectively reduced at around 350 to 400° C.

### First Embodiment

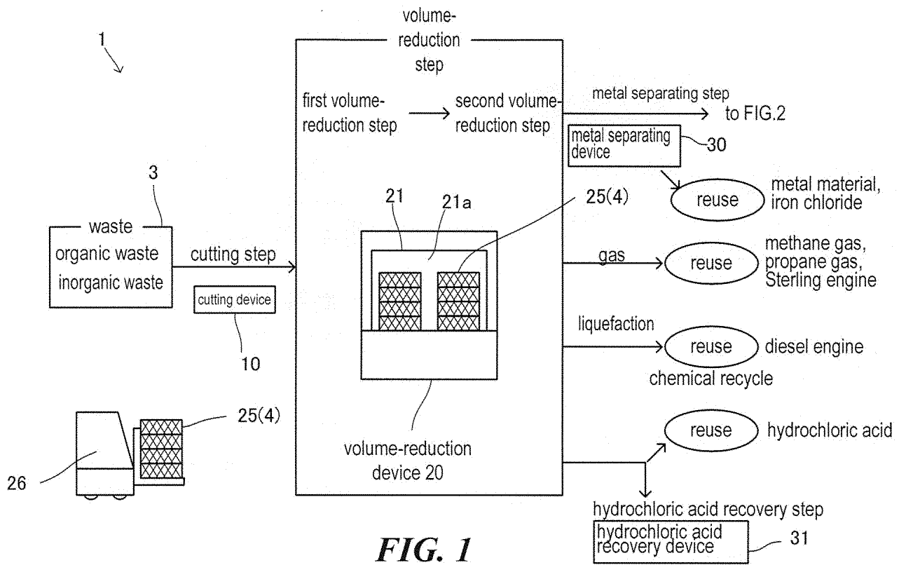

The volume reduction processing method and the volume reduction processing system according to the first embodiment shown in FIGS. 1 to 4 are described in detail.

### <Volume Reduction Method>

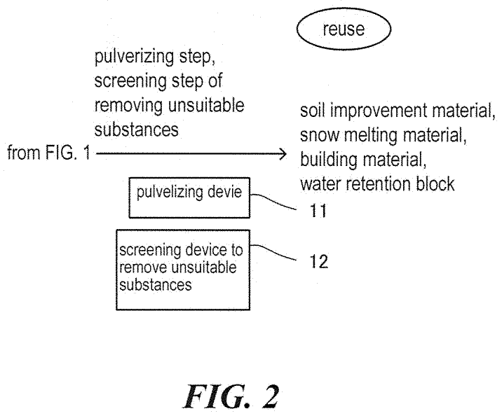

As shown in FIGS. 1 and 2, in addition to the above-mentioned volume reduction step, the volume reduction method includes a cutting step to be executed before the volume reduction step, a metal separating step of extracting residual metal material after the volume reduction step, a pulverizing step of pulverizing the volume-reduced material, that is carbonized material, produced by the volume reduction step into a predetermined particle size, and a screening step of removing unsuitable substances by sieving. Further, the volume reduction step includes the second volume reduction step that is selectively executed after the first volume reduction step. In addition, it is also possible to execute a hydrochloric acid recovery step after the volume reduction step.

The metal separating step and the hydrochloric acid recovery step can be executed after the volume reduction step, that is, after the first volume reduction step or the second volume reduction step, both steps can be executed in parallel.

Hereinafter, each step is described. Here, the volume reduction processing method including the cutting step is described as an example, but carbonization is possible without the cutting step to be mentioned below as long as the waste 3 contains plastic waste having the size of about 5 cm (fist-sized) to 10 cm. For example, the waste 3 such as a mobile phone in which resin material and metal material are integrated can be treated as it is.

### <Cutting Step>

The cutting step is a process of cutting the organic waste being the raw material into flakes (thin pieces), and is executed using a cutting device 10. The cutting device 10 is not particularly limited, and a known cutting device can be used. The size of the waste to be cut into flakes can be determined for each rank in another embodiment to be described later, but is not particularly limited in the present embodiment, and can be about 2 to 10 cm. The cut product 4 can be accommodated in a volume reduction container 25 having a mesh-like side face so as to be easily handled during carbonization.

The cut product 4 and other waste 3 (for example, combination of inorganic waste and organic waste) produced by such a cutting step are accommodated in the volume reduction container 25, and the volume reduction containers 25 containing the cut product 4 and other waste is stacked in a volume reduction furnace 21 of the volume reduction device 20 using a forklift 26, referring to FIG. 1. It is desirable that the volume reduction container 25 is configured so as not to have space between the cut products 4. This is because the smaller the amount of spaces, the better the carbonization efficiency. The waste 3 other than the cut product 4 can be directly accommodated in the volume reduction furnace 21 without being accommodated in the volume reduction container 25.

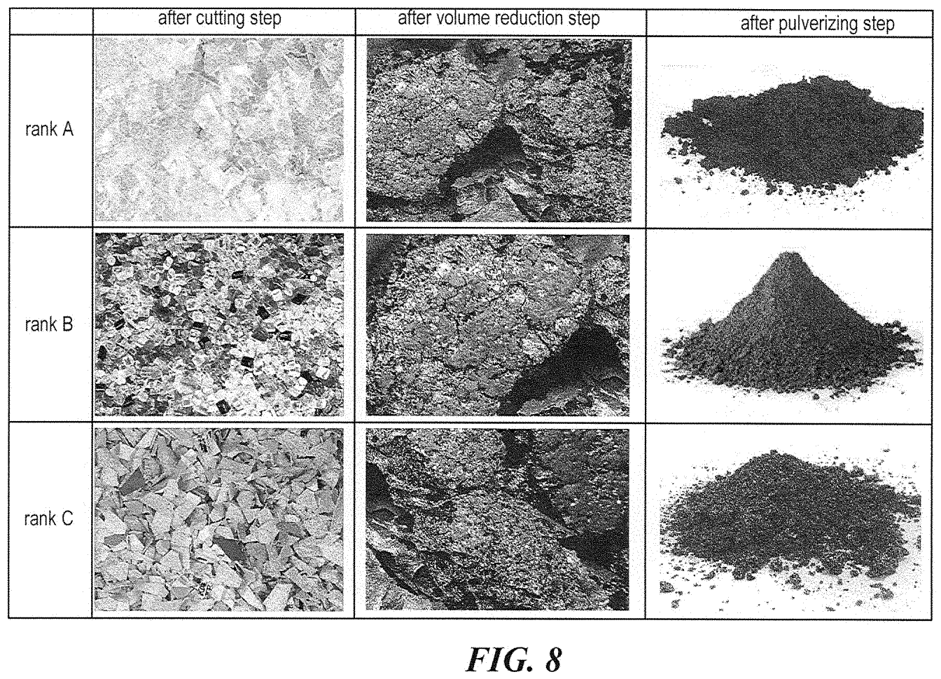

The column “after the cutting step” in the table of FIG. 8 shows a photograph of the state of the waste 3 containing plastic waste after the cutting step.

### <Volume Reduction Step>

In the volume reduction step, the thermal decomposition of organic waste is executed using such a volume reduction device 20, and an example using a batch-type carbonization device by superheated steam as the volume reduction device 20 is described. In this case, the volume reduction container 25 containing the cut product 4 needs only to be placed in a predetermined place in the volume reduction furnace 21.

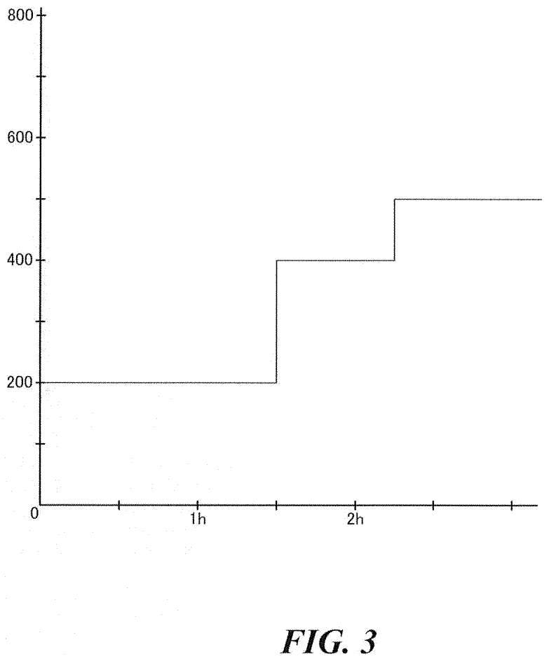

The thermal decomposition of the cut product 4 is performed while raising the temperature in the volume reduction furnace 21 in stages as described above. For example, as illustrated in FIG. 3, the temperature is raised in multiple stages. As an example, the volume reduction furnace 21 capable of carbonizing the cut product 4 having a monthly production of 100 tons is specifically described.

When a start button of the volume reduction furnace 21 is turned on, a heating burner turns on, and the inside of the volume reduction furnace 21 is heated to and maintained at around 200° C. Then, the volume reduction container 25 accommodating the cut product 4 and other waste 3 is stored in the volume reduction furnace 21 sealed in an oxygen-free state, and heated for about 100 minutes. This is the first volume reduction step.

When the carbonization and volume reduction of the cut product 4 are almost finished by executing the first volume reduction step, the volume reduction step can be terminated. It is enough that the organic waste becomes carbonized material of which volume is reduced to 20 to 30% by the heat processing.

When carbonization is insufficient, the second volume reduction step can be continuously executed. In the second volume reduction step, the temperature in the volume reduction furnace 21 is raised within a range of at least 350 to 400° C., the waste is heated for a predetermined time, and the volume is reduced. For example, the volume reduction furnace 21 can be heated at around 400° C. for about 1 hour, then heated to 500 to 550° C. for another 30 to 50 minutes, referring to FIG. 3. In this way, by combining the first volume reduction step and the second volume reduction step, the organic waste is made into carbonized material of which volume is reduced to 20 to 30%.

The organic waste containing urethan can be heated to about 500° C. Further, the organic waste containing a large amount of vinyl chloride can be heated to 800 to 850° C. for 1 to 3 hours.

When thermoplastic resin is contained in the plastic waste in the waste 3 and is suddenly treated at a high temperature, the thermoplastic resin melts and disappears. On the other hand, when thermosetting resin is contained, it is hardened and becomes a lump, so that it is difficult to obtain high-quality carbonized material. However, in this volume reduction processing system, since the temperature is raised stepwise from about 200° C. multiple times, the waste is carbonized regardless of properties such as thermoplasticity and thermosetting properties.

Thus, it is possible to reduce 100 tons of the cut product 4 produced per month to 20 to 30 tons of carbonized material per month which is uniform and has good quality. In addition, the organic waste can be reduced to 20 to 30% in volume, thereby storing and handling of the carbonized material easily.

The column “after the volume reduction step” in the table of FIG. 8 shows a photograph of the state of the carbonized material produced by the above-described method.

A heating burner for heating the volume reduction furnace 21 in the volume reduction step is not particularly limited, but a burner or the like that uses kerosene or the like as fuel is adopted.

Furthermore, microwave heating can be performed in the volume reduction furnace 21 in addition to normal heating. In this case, since the cut product 4 is heated from the inside when microwave is irradiated, the temperature rising speed is increased, and the processing time is shortened. In this case, the cut product 4 is heated from the inside by microwave in addition to normal heating from the outside, so that uniform, even and high-quality carbonized material is obtained.

In order to carbonize the plastic waste contained in the waste 3, it is preferable to perform a thermal decomposition processing in an oxygen-free or a low-oxygen state unlike the case where household waste is incinerated into ash. Carbon dioxide is generated in the case of incineration, but in the case of thermal decomposition in an oxygen-free or similar state, carbon dioxide is scarcely generated, and the organic waste is carbonized and solid carbon is obtained.

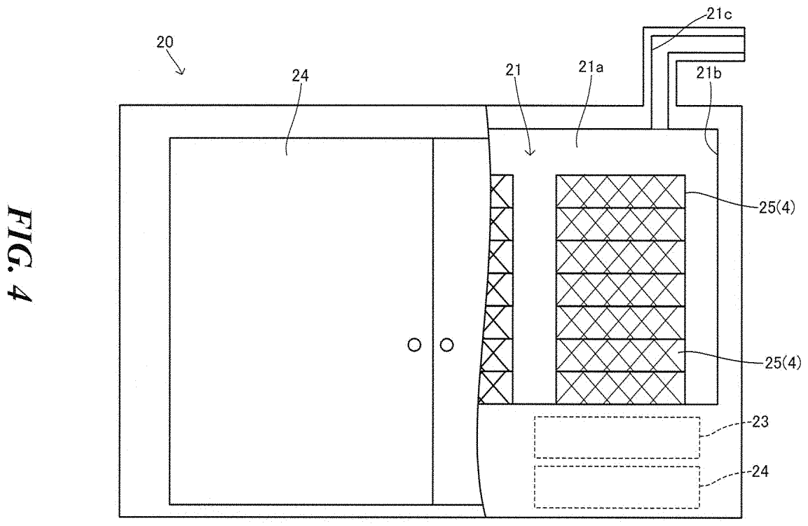

The volume reduction device 20 is not particularly limited and a known volume reduction device capable of raising temperature in stages can be used. Here, a batch-type device using superheated steam is described. As shown in FIG. 4, the volume reduction device 20 includes the volume reduction furnace 21 in which the volume reduction containers 25 are stored in a stacked state, a heating section 23 that heats a volume reduction furnace space 21a to carbonize the cut product 4, a control section 22 that controls the heating section 23 so as to raise and maintain the temperature in the volume reduction furnace space 21a to a predetermined temperature, and a sealing door 24 that seals the volume reduction furnace 21 in order to be an oxygen-free state. Further, the volume reduction furnace 21 is provided with an outlet 21c for discharging dry distillation gas.

The volume reduction furnace 21 has the volume reduction furnace space 21a in which the volume reduction containers 25 are stored in a stacked state. In order to achieve nearly complete carbonization, it is desirable to use a double-structure sealed type furnace capable of blocking oxygen. The wall portion of the volume reduction furnace 21 can be metal. Considering long-term use, at least an inner wall 21b side of the volume reduction furnace 21 is desirably formed of a heat-resistant brick or a refractory brick having heat resistance of 2000° C., for example. The heat-resistant brick and the refractory brick are resistant to chlorine gas and are used suitably. Further, it is desirable to apply heat-resistant paint to the inner wall 21b for long-term use of the volume reduction furnace 21.

The heating section 23 of the volume reduction device 20 is configured to use superheated steam as a direct heating source, and the temperature of the volume reduction furnace space 21a is kept constant by convection of the superheated steam. Due to such a convection effect, a plurality of stored volume reduction containers 25 are heated so as to keep uniform temperature.

The control section 22 consists of a CPU, a program, and so on, and raises and maintains the temperature of the volume reduction furnace space 21a in cooperation with the heating section 23 and a temperature detection section, not shown.

The sealing door 24 is provided for sealing the volume reduction furnace 21 in an oxygen-free state, and it is desirable to arrange a large door as shown in FIG. 4 so that a plurality of volume reduction containers 25 are put in and taken out by the forklift 26.

Since the volume reduction device 20 as mentioned above has a sealed structure, oxygen is blocked, generation of carbon dioxide by oxygen is reduced, and the accuracy of carbonization and the purity of the carbonized material are improved. In addition, since the volume reduction device 20 is of batch type, such a device is better in cost performance than a rotary type device, and it is easier to increase the number of installations depending on the processing amount. Further, carbonization is advanced without solidification of waste when the volume reduction processing is performed with the volume reduction container swung. Such a processing is not necessary depending on the amount of waste to be carbonized at a time, and in any case, since a mechanism such as stirring for the rotary type device is unnecessary, the cost (initial cost) of the device itself is reduced.

In the volume reduction processing, various compounds, water, dry distillation gas (carbon dioxide, flammable gas, etc.) are generated together with carbonized material as a result of the thermal decomposition reaction. For example, when PET bottles, i.e., PET (polyethylene terephthalate), are thermally decomposed, terephthalate acid, which is polymerization raw material for PET, is obtained. Namely, in such a volume reduction processing, the efficiency of recycling PET bottle waste by chemical methods is improved.

Further, the dry distillation gas generated by carbonization can be used as thermal energy. Specifically, it can be reused for a Stirling engine that converts dry distillation gas into electricity. By such use of dry distillation gas, the running cost of the volume reduction processing is reduced.

Of course, the generated gas, i.e., hydrocarbon, can be oiled to produce generation oil. Namely, chemical recycling, i.e., returning plastics to petroleum, is realized. The generation oil is used for fuel for internal combustion engines such as diesel engines, reciprocating engines, and rotary engines, as well as other mechanical fuels, boiler fuels, power generation, etc.

Here, the example of carbonization in which the volume reduction container 25 accommodating the cut product 4 is placed in a predetermined place of the volume reduction furnace 21 to be carbonized is explained, but it goes without saying that a simple swing mechanism for swinging the volume reduction container 25 can be added. In this case, uniform and high-quality carbonized material without unevenness is obtained by mass processing.

Further, an amine-based gel can be provided at a gas discharge passage such as the outlet 21c to absorb and dissipate carbon dioxide generated by the volume reduction processing, and to react with hydrogen to produce methane gas and methanol. In this way, useful substances such as methane gas are separated and recovered, and carbon dioxide emission is reduced.

Examples of the compounds produced by thermal decomposition of waste 3 include the followings.
saturated hydrocarbons such as methane, ethane, propane, butane, etc.
unsaturated hydrocarbons such as ethylene, propylene, butylene, butadiene, benzene, toluene, xylene, styrene, etc.
oxygen-containing hydrocarbons such as methanol, ethanol, acetone, methyl ethyl ketone, formic acid, acetic acid, propionic acid, formaldehyde, acetoaldehyde, etc.
carbon dioxide, ammonia, nitrogen (small amounts)

Since these hydrocarbons are flammable gases, they are reused for fuel.

In addition to the above, a volume reduction furnace of swing drum type or fluidized bed type can be adopted as the volume reduction device 20. For example, in the case of a drum type volume reduction furnace, the volume reduction step is performed continuously in such a manner that the volume reduction furnace space is divided into a plurality of zones, the temperature is raised in stages, and a blow fan and an air chamber are provided. In the case, since the volume reduction processing is performed more continuously than the batch type volume reduction furnace mentioned above, it is suitable for the case in which the waste 3 containing a large amount of plastic waste is processed. When the swing drum type volume reduction furnace is used, unlike the fluidized bed type furnace to be mentioned later, equipment is installed in the surrounding area because the furnace swings without rotation.

Although it is not shown in the figures, the waste heat generated in the processing step in the volume reduction device 20 can be recovered in a boiler, or a re-combustion system can be constituted such that the secondary combustion chamber for secondary combusting dry distillation gas generated from the volume reduction device 20 is provided.

### <Hydrochloric Acid Recovery Step>

In the case that chlorine-containing synthetic resin is contained in the waste 3, when the chlorine-containing synthetic resin is thermally decomposed with the volume reduction device, the carbonized material from which chlorine is removed is produced, and hydrogen chloride (hydrochloric acid gas) which is harmful substance is also generated.

The volume reduction processing system 1 is configured such that a hydrochloric acid recovery device 31 is provided for the downstream of the volume reduction device, and hydrogen chloride is recovered and generated as hydrochloric acid with the hydrochloric acid recovery device 31. Examples of the hydrochloric acid recovery device 31 include a Venturi scrubber, a water spraying device, and the like.

In such a configuration, even if harmful hydrogen chloride is generated by the volume reduction processing, the hydrogen chloride is converted to hydrochloric acid and a harmful gas is prevented from spreading.

Further, a chloride compound and a fluoride compound are generated by reacting gas containing chlorine and fluorine with metal material, i.e., aluminum, iron, zinc, copper, etc., accommodated in the volume reduction furnace 21. Such compounds are highly purified by separation and refinement using the sublimation property. For example, iron chloride produced by reacting of iron with hydrogen chloride produces high purity iron chloride by repeating sublimation at 280° C. For copper chloride, sublimation is repeated at a higher temperature. Iron oxide is further resolved to be raw material for powder metallurgy, i.e., a method for casting and sintering metal powder to produce a metal product.

Iron chloride is used as oxidants, catalysts, and analytical reagents in organic chemical reactions, as well as for iron salt production, pigments, inks, mordants, hemostatic agents, and astringents. Copper chloride is used as catalysts desulfurization agents, mordants in dyeing, oxidants of aniline dyes, and for deodorization of petroleum refining, and so on, and is widely used for recovery of mercury from ores, plating, photographs, and as glass coloring pigments, wood preservatives, disinfectants, etc.

Thus, by heat processing of inorganic waste containing metal material with organic waste in an oxygen-free state, the products thus produced are reused for various applications.

### <Metal Separating Step>

After the above volume reduction step, carbonized material and non-carbonized inorganic waste are extracted from the volume reduction container 25, and the residual metal material is extracted from the carbonized material and the non-carbonized inorganic waste with a metal separating device 30. Examples of the metal separating device 30 include those using specific gravity, magnetism, optical systems, or the like.

Since the metal separating step is executed after the volume reduction step, it is easy to extract the residual metal material from the volume-reduced waste 3. In particular, in the case of the waste 3 in which the plastic and the metal material are integrated, the carbonized material and the metal material are separated by thermal decomposition, thereby facilitating extraction of the metal material. As described above, iron chloride and copper chloride are also obtained.

After the above-mentioned volume reduction step, the carbonized material is extracted from the volume reduction container 25, then a pulverizing step in which the carbonized material is further pulverized to a predetermined particle size and a screening step of removing unsuitable substances by sieving are executed.

### <Pulverizing Step>

In the pulverizing step, a pulverizing device 11 to pulverize the carbonized material to a predetermined particle size is used. The carbonized material can be pulverized, for example, to 100 to 500 μm using the pulverizing device 11. In the column “after the pulverizing step” in the table of FIG. 8, the state of the carbonized material after the pulverizing step is shown in a photograph.

### <Screening Step of Removing Unsuitable Substances>

In the screening step, a screening device 12 for removing unsuitable substances by sieving is used. Examples of the screening device 12 include a vibration sieving device and a magnetic selection device, although they are not particularly limited.

The pulverized carbonized material in which the unsuitable substances are thus removed is used for soil improvement material, snow melting material, building material, a water retention block, and so on like the pulverized carbonized material in a rank C, to be described in detail in the description of the embodiment shown in FIGS. 3 and 4.

Conventionally, since carbonization of not only plastic waste but also waste starts from 400° C. or more, carbonization processing was usually performed by steam heating in the carbonization furnace heated to 500 to 600° C. or more. However, in such a case, although there is no problem with the waste which is easily carbonized, the waste which is not easily carbonized melts to be solidified, and remains without uncarbonized, thereby having difficulty in recycle.

For example, in the case of a carbonization device called as a fluidized bed type, since the waste is continuously carbonized, it is preferable to process a large amount of waste as described above. However, in the fluidizing bed type carbonization device, the waste is carbonized with humidified air while being stirred with fluidizing sand and a small amount of air in the carbonization furnace which rotates and has a cylindrical shape, and the powdered carbonized material is recovered at the upper portion of the carbonization furnace. Therefore, in the case of a large-sized device, it is necessary to increase the size of the stirring mechanism, the rotating mechanism, the recovery mechanism, and the like, so that there is a concern for cost increase. Also, the incomplete carbonized material is discharged from the bottom together with the fluidizing sand without being recovered, and therefore, it is disadvantageous that complete recycling of waste 3 containing plastic waste is not achieved. Furthermore, in the case of processing a large amount of waste, it is also important to perform the carbonizing step while constantly stirring the waste by the stirring mechanism so as not to form a large mass.

It is demonstrated by various tests by the inventors of the present invention that the above-mentioned carbonization by increasing temperature in stages enables the waste 3 containing plastic waste to be carbonized uniformly and with good quality. According to the method described above, the volume of organic waste such as plastic waste is reduced to 20 to 30% by carbonization, e.g., about 30 tons of organic waste is converted to about 6 tons of carbonized material, and most of the carbonized material is reused.

Further, since it takes time to raise the temperature in the furnace to a predetermined temperature depending on the size of the volume reduction furnace 21, when a plurality of furnaces in which carbonization is completed by a time difference are provided, and the replacement method is used, an efficient carbonization step is performed.

Furthermore, when the waste 3 containing plastic waste is put into the volume reduction device 20 having the volume reduction furnace 21 as described above, the temperature-controlled volume reduction device 20 is operated for a predetermined time, so that the carbonization processing is easily performed even by a user who does not have specialized knowledge. Therefore, when such a system is introduced into a factory which has a trouble of disposing of the waste 3, the waste 3 containing defective products generated in manufacturing is processed so as to be recycled.

The volume reduction processing method and the volume reduction processing system in the present embodiment are applied not only to a processing facility of a local government but also to a disposal processing system in a factory of a private company, for example. Especially, in the case of the batch type volume reduction device 20 described above, compared with the rotary type or the screw type volume reduction device, the installation area is small, the cost is easily reduced, the device is capable of smokeless, and cooling water is unnecessary, so that the device is applied to from a small-scale processing to a large-scale processing.

### Second Embodiment

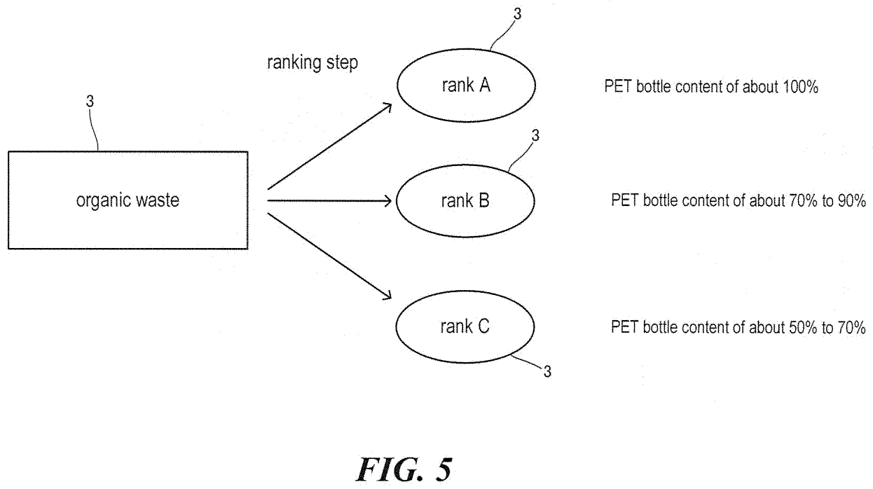

Next, a volume reduction processing method and a volume reduction processing system according to the second embodiment shown in FIG. 5 to FIG. 7 are explained. FIG. 8 is a table with actual photographs respectively showing ranked waste 3 containing plastic waste after the ranking step in the volume reduction processing method in the second embodiment.

Like the embodiment in FIG. 1, in the volume reduction processing method, the cutting step, the volume reduction step (the first volume reduction step or the second volume reduction step), the metal separating step, the hydrochloric acid recovery step, the pulverizing step, and the screening step of removing unsuitable substances are executed. Before the cutting step, the ranking step of classifying waste into a plurality of ranks based on the PET bottle content is executed. The cutting step is described here as well, but it is the same as the first embodiment in that the cutting step can be omitted. The waste 3 includes both organic waste such as plastic and inorganic waste such as metal material like the embodiment in FIG. 1.

As shown in FIG. 5, in the ranking step, the organic waste is classified into three ranks A, B, and C based on plastic purity. Here, the plastic purity is the content of the main plastic waste contained in the waste 3. Examples of the main plastic waste include polyethylene terephthalate (PET) and polyurethane (PU). FIG. 5 is an explanatory figure using PET bottles as an example. The waste in the rank A has the PET bottle content of about 100%, the waste in the rank B has the PET bottle content of about 70 to 90%, and the waste in the rank C has the PET bottle content of about 50 to 70%. Such ranking can be performed manually or by a machine.

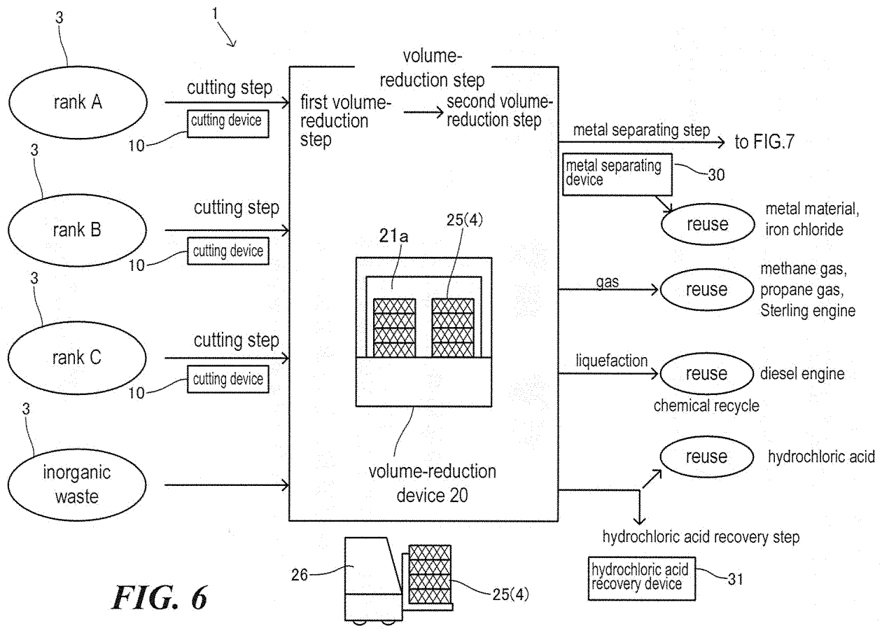

In the volume reduction processing of waste 3 containing organic waste such as plastic waste classified into ranks, as shown in FIG. 6, the cutting step and the volume reduction step are executed in order in the same manner as in the first embodiment. The cutting step is executed using the cutting device 10 for each rank, for example, the waste in the rank A is cut to about 0.5 mm to 3 mm, the waste in the rank B is cut to about 0.5 to 3 cm, and the waste in the rank C is cut to about 5 to 10 cm. This cutting dimension is not particularly limited.

In the column “after the cutting step” of the table of FIG. 8, photographs of the waste 3 containing plastic waste after cutting the waste in the rank A, B, or C are shown. As seen from FIG. 8, the waste in the rank A is composed of only transparent PET bottle material because the content of PET bottles is about 100%. As seen from FIG. 5, since the content of PET bottles in the rank B is about 70 to 90%, the rank B mostly includes transparent PET bottles, but the presence of colored plastic material is observed, and the rank B contains a mixture of thermosetting resin and thermoplastic resin. Further, as seen from FIG. 8, since the content of PET bottles in the rank C is about 50 to 70%, not only the plastic material excluding the PET bottles, the thermosetting resin, and the thermoplastic resin are mixed, but also the presence of waste such as a wood piece, rubber, paper, and the like whose material is not able to be specified is observed.

After cutting the classified waste 3 containing the organic waste, the volume reduction step is also executed using the volume reduction device 20 for the waste in each rank. Further, the volume reduction processing is performed for the inorganic waste by the volume reduction device 20 like the organic waste in the embodiment in FIG. 1.

In the column “after the volume reduction step” in the table of FIG. 8, after carbonization of the waste in the rank A, B, or C, the state of each carbonized material is shown in the photograph. As described above, according to the processing method of one aspect of the present embodiment, it is possible to obtain homogeneous carbonized material without discernible difference in appearance when viewed from a black-and-white photograph.

As for the volume reduction step, as shown in FIG. 6, the waste in the volume reduction container 25 for each rank can be carbonized while the volume reduction container 25 is provided in the volume reduction furnace 21 of the volume reduction device 20 in rows. Details of the cutting step and the volume reduction step (volume reduction device 20) are the same as those in the embodiment of FIG. 1, therefore description thereof is omitted.

After the volume reduction step, the metal separating step, the hydrochloric acid recovery step, the pulverizing step, and the screening step of removing unsuitable substances are performed as in the embodiment of FIG. 1. Since the metal separating step and the hydrochloric acid recovery step are the same as those in the embodiment of FIG. 1, description thereof is omitted.

In the pulverizing step after extracting the metal material, for example, the waste in the rank A can be pulverized to 5 to 8 μm, the rank B can be pulverized to 10 to 30 μm, and the rank C can be pulverized to 100 to 200 μm. In the column “after the pulverizing step” in the table of FIG. 8, the state after pulverizing the waste in the ranks A, B, and C, respectively, is shown by photographs. The photograph of the waste in the rank A after the pulverizing step shows very fine and homogeneous carbonized material, i.e., activated carbon. The photograph of the rank B after the pulverizing step also shows very fine and homogeneous activated carbon, i.e., activated carbon. The photograph of the rank C after the pulverizing step shows whitish appearance because it is made black and white, but the whitish substances are not impurities and the waste is uniformly carbonized.

The pulverized carbonized material after the screening step of removing unsuitable substances is rendered into different steps depending on the rank. An activating step is executed for the rank A and the rank B, and the activating step can be executed for the rank C, but it is unnecessary depending on the purpose of usage.

More specifically, activated carbon having a specific surface area of 3,000 to 3,600 m²/g is formed by performing an alkali activation processing in a carbon activation device 13 composed of a hybrid carbonization furnace using microwaves and heat. For the waste in the rank B, steam activation is performed in another carbon activation device 13, and activated carbon having a specific surface area of 500 to 1,000 m²/g is formed.

Although the volume reduction device 20 can be shared as the carbon activation device 13, since the activation processing is required to be executed at a higher temperature than the volume reduction processing, it is desirable to make the volume reduction furnace 21 heat-resistant and fire resistant as described above. Various devices such as batch type and rotary type are used as the carbon activation device 13.

The activated carbon thus formed can be pulverized to a predetermined particle size using a pulverizing device, not shown, such as a jet mill, depending on the purpose of recycling.

### <Rank A>

The carbonized material in the rank A is activated carbon derived from polyethylene terephthalate containing almost no substances other than PET bottles, and the carbonized material in the rank A with a particle size of 10 μm or less is used as activated carbon for electrode material such as a rapid charge/discharge capacitor (EDLC) of an electric vehicle. The rapid charge/discharge capacitor is formed by coating activated carbon on the surface of a current collector such as an aluminum foil, and stores electricity on the surface. The activated carbon derived from polyethylene terephthalate with a large specific surface area and complicated pore structure has a concern in response characteristics when the current density is increased. However, by reducing the particle size to 10 μm or less, not only high discharge capacity but also good speed characteristics are simultaneously achieved. The activated carbon in the rank A is used not only as the electrode material of a fuel cell, but also as the catalyst with high performance, the adsorbent of harmful substances, and the yarn of high function fibers.

### <Rank B>

The carbonized material in the rank B is activated carbon containing substances other than PET bottles at the rate of about 10 to 30%, and is used for filters of air conditioners and automobiles, deodorants, purifying agents, and the like by reducing the particle size into 10 to 30 μm or less. A porous sheet is used as the filter body, and the filter is formed by containing activated carbon in the sheet. Micropores are formed in the activated carbon, and various odor components are adsorbed and decomposed when artificial enzymes having the function of oxidizing the odor components with active oxygen to convert the odor components into other substances, and the function of decomposing the odor components are stored in the micropores.

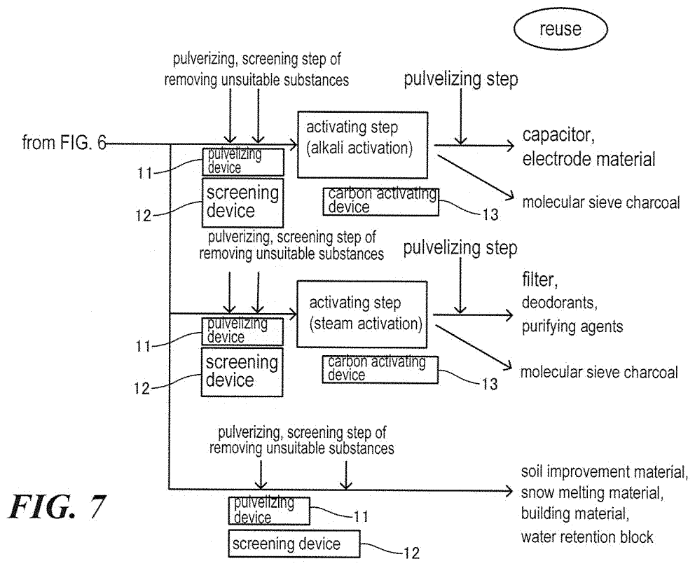

Further, molecular sieve charcoal, which is a kind of activated carbon, is able to be formed by activating the carbonized material in the rank A and the rank B having high purity, referring to FIG. 7. The molecular sieve charcoal is used for the purpose of confining, i.e., adsorbing, molecular-sized gases using micropores. That is, when the difference in the size of a plurality of gas molecules is utilized, plural kinds of gases are separated by the molecular sieve charcoal. Examples of the molecular sieve charcoal include molecular sieve charcoal that adsorbs oxygen in the air to separate nitrogen, molecular sieve charcoal that adsorbs methane, and molecular sieve charcoal that adsorbs harmful gases, and so on.

The molecular sieve charcoal needs to have micropores corresponding to the molecular size of the gas depending on the type of gas to be confined. The size of the micropores is adjusted to a desired one by adjusting the temperature of the furnace of the carbon activation device 13, the amount of activation gas, and the duration of activation.

### <Rank C>

Conventionally, the waste in the rank C containing a large amount of impurities other than PET bottles is often reclaimed or dumped, thereby causing a serious environmental problem. However, even if the pulverized carbonized material in the rank C in the present embodiment includes the substances other than PET bottles by about 30 to 50%, the carbonized material in the rank C is uniform and has good quality, and thus the carbonized material in the rank C is used as soil improvement material, snow melting material, building material, water retaining block, or the like. As soil preservation/improvement material, it can mix the pulverized carbonized material in the volume ratio of about 10%. Thereby, clayish hard soil is made soft, and the water permeability and the water retention of the soil are improved.

In addition, since the soil is made alkaline, it has been clarified by the experiment of the inventors that growing condition becomes good when agricultural crops, flowers, and grass are grown in this soil. Moreover, such alkaline soil is suitable for organic cultivation because soil bacteria are easily fixed, and is effective as a measure against acid rain and soil flow, and therefore, the alkaline soil is epoch-making as an effective use of waste containing plastic waste which had to be landfilled or dumped in the past. As the snow melting material, for example, the carbonized material solidified in a block shape is arranged on a road surface or on a roof as a tile, whereby the carbonized material is used as a snow melting road or a snow melting tile in cold districts using heaters or sunlight due to the heat conduction and diffusion action of carbonized material.

In addition, experiments by the inventors have shown that, when blocks containing pulverized carbonized material in the rank C are laid in waterways and rivers, the carbonized material adsorbs nitrogen, phosphorus, and the like, and microorganism settled in the water decomposes harmful substances, thereby purifying the water. As described above, even the carbonized material in the rank C obtained from the waste containing low-purity plastic waste is effectively utilized for various applications without being discarded.

Activated carbon is utilized as molecular sieve charcoal that confines (adsorbs) gases of a specific molecular size in fine pores. That is, gas can be separated by molecular sieve charcoal according to the size of a plurality of gases. Examples of the molecular sieve charcoal include molecular sieve charcoal that adsorbs oxygen in the air to separate nitrogen, molecular sieve charcoal that adsorbs methane, and molecular sieve charcoal that adsorbs harmful gases.

According to the volume reduction processing method and the volume reduction processing system 1 of the above-described embodiments, the waste 3 containing organic waste such as plastic waste is efficiently reduced, and as a result, the obtained carbonized material, gas, and other compounds are effectively used for various applications as described above. In addition, generation of harmful substances such as dioxins and carbon dioxide is reduced.

In addition, since the paper waste and the wood waste contained in the organic waste are also carbonized, it is not necessary to separate them before the volume reduction processing, and the labor and effort of waste disposal are saved. For example, the newspaper can also be thermally decomposed in a compressed state. The volume of plastic bags can also be reduced by being compressed.

Such a volume reduction processing system 1 contributes to the solution of illegal dumping and marine pollution, which have been regarded as social problems in recent years. In addition, since the waste 3 contains much waste other than plastic waste is effectively reused, it is also possible to aim for zero disposal of the waste 3 containing plastic waste.

Recently, a huge amount of plastic waste flows into the oceans in the world, and becomes a microbead of 5 mm or less by being crushed by waves and ultraviolet rays to drift in the sea, thereby causing a microplastic problem such that the microbead is difficult to be collected. Plastic waste has the property of adsorbing and concentrating harmful substances such as PCBs, and accumulates in fish and seabirds which swallow the plastic waste, thereby adversely affecting the ecosystem. Data is reported such that the plastic waste is extracted from the stomach of about 80% of anchovy in Tokyo Bay. At this rate, 300 million tons of plastic flow to the ocean per year, and in 2050, a larger amount of plastics than the amount of the world's fish will flow out into the sea, and the sea will be dead.

It is said that Japan discharges 92 million tons of plastic waste a year. About 70% of it is incinerated, when the plastic reaches high temperature at the time of incineration and quickly damages the furnace. In addition, a lot of carbon dioxide is discharged with combustion, and it goes against the global warming countermeasure. The waste incinerator in a town with the population of 400,000 costs about 10 billion yen, is replaced by a lifetime of 30 years, and costs a huge amount of money to demolish. The cost of removing harmful substances such as dioxins and heavy metals is added, and it costs several times as much as that of incinerators. In addition, although 27% of plastic waste is recycled for reuse, recycling changes the view of problems and does not reduce plastic waste, and the plastic waste is increasing.

Cellulose and biomaterials are actively deemed to be plastic reduction or conversion to alternative material, but like the biofuels which were popular in the past, the costs are high, and the raw material is trees and foods, thereby reversing the logical order of things, leading to natural destruction and food shortages, and having serious impact on human. Among plastic waste, straws and plastic bags are less than 1% of the total. Automotive paints, ships, airplanes, houses, furniture, etc. use synthetic polymer material. There is no substitute for material that is cheap, strong, convenient for humans, and help rich lives.

However, when the above-described volume reduction processing method and the volume reduction processing system 1 are adopted, organic waste containing plastic waste is reduced to 20 or 30% in volume. In this way, even if synthetic polymer (plastic) products that are not decomposed even after 1,000 years are produced as before, they are safely reduced.

Further, the waste of electrical products such as home appliances and mobile phones is often integrated waste of metal material and resin material, and in case of incineration, it is necessary to disassemble and separate each material, but when the volume reduction processing method and the volume reduction processing system 1 are used, such a need is not necessary, and waste processing is performed simply. Furthermore, for example, a large amount of expired food at a supermarket is also able to be disposed of with a resin package attached. Of course, the organic waste among these wastes is capable of recycling as described above.

In addition, a large amount of waste generated at construction sites and demolition sites and a lot of disaster waste generated by natural disasters are processed by the volume reduction processing method and the volume reduction processing system 1 as described above, and are recycled by carbonization by thermal decomposition. In addition, it contributes to disaster recovery by being able to quickly process and reduce the volume of wood waste caused by earthquakes and typhoons.

### REFERENCE SIGNS LIST

1 waste volume reduction processing system
3 waste
4 cut product
10 cutting device
11 pulverizing device
12 screening device to remove unsuitable substances
13 carbon activating device
20 volume reduction device
21 volume reduction furnace
21a volume reduction furnace space
21b interior wall
22 control section
23 heating section
24 sealing door
25 volume reduction container
26 forklift
30 metal screening device to extract residual metal material
31 hydrochloric acid recovery device

1. A waste volume reduction processing method comprising a volume reduction step of reducing volume of waste in a volume reduction furnace in which temperature is raised in stages multiple times,
wherein the waste is a mixture of organic waste containing plastic and inorganic waste containing metal material,
wherein the volume reduction step comprises a first volume reduction step of storing and heating the waste in the volume reduction furnace in which temperature is raised up to and is maintained at around 200° C., the volume reduction furnace being sealed in an oxygen-free state or in a low-oxygen state, and
wherein the organic waste is reduced in volume to 20% to 30% of original volume.

2. The waste volume reduction processing method according to claim 1, wherein in the volume reduction step, after the first volume reduction step, a second volume reduction step is selectively executable such that the temperature of the volume reduction furnace is raised up to a range from 350 to 400° C., the waste is heated for a predetermined time, and volume of the waste is reduced.

3. The waste volume reduction processing method according to claim 1, the method comprising a metal separating step of extracting the metal material after the first volume reduction step.

4. The waste volume reduction processing method according to claim 1, the method comprising a hydrochloric acid recovery step of recovering discharged hydrogen chloride gas as hydrochloric acid after the first volume reduction step.

5. The waste volume reduction processing method according to claim 1, the method comprising a ranking step of classifying the waste into a plurality of ranks based on plastic purity before the volume reduction step.

6. The waste volume reduction processing method according to claim 1, the method comprising a pulverizing step of pulverizing the waste obtained in the volume reduction step into a predetermined particle size and a screening step of removing unsuitable substances by sieving.

7. The waste volume reduction processing method according to claim 1, the method comprising an activating step of activating carbonized material of which volume is reduced in the volume reduction step to produce activated carbon.

8. A waste volume reduction processing system, comprising:
a volume reduction device in which volume of waste is reduced in an oxygen-free state or in a low-oxygen state at 200° C., and then the waste is selectively reduced in volume at 350 to 400° C., the waste being a mixture of organic material containing plastic and inorganic material containing metal material; and
a metal separating device to extract residual metal material.

9. The waste volume reduction processing system according to claim 8,
the volume reduction device comprising:
a volume reduction furnace space in which containers accommodating the waste so as not to make space between the waste are stacked, the containers having mesh side faces;
a heating section to heat the volume reduction furnace space to reduce volume of the waste;
a control section to control the heating section so as to raise and keep temperature in the volume reduction furnace space to a predetermined value; and
a sealing door to keep the volume reduction furnace space in an oxygen-free state or in a low-oxygen state.

10. The waste volume reduction processing system according to claim 8, the system comprising a hydrochloric acid recovery device of recovering hydrogen chloride gas produced in the volume reduction device as hydrochloric acid.

11. The waste volume reduction processing system according to claim 8, the system comprising a pulverizing device to pulverize the waste of which volume is reduced in the volume reduction device into a predetermined particle size and a screening device to remove unsuitable substances by sieving.

12. The waste volume reduction processing system according to claim 8, the system comprising an activating device to activate the carbonized material of the waste of which volume is reduced in the volume reduction step to produce activated carbon.

13. The waste volume reduction processing method according to claim 2, the method comprising a metal separating step of extracting the metal material after the first volume reduction step or the second volume reduction step.

14. The waste volume reduction processing method according to claim 2, the method comprising a hydrochloric acid recovery step of recovering discharged hydrogen chloride gas as hydrochloric acid after the first volume reduction step or the second volume reduction step.

15. The waste volume reduction processing method according to claim 2, the method comprising a ranking step of classifying the waste into a plurality of ranks based on plastic purity before the volume reduction step.

16. The waste volume reduction processing method according to claim 2, the method comprising a pulverizing step of pulverizing the waste obtained in the volume reduction step into a predetermined particle size and a screening step of removing unsuitable substances by sieving.

17. The waste volume reduction processing method according to claim 2, the method comprising an activating step of activating carbonized material of which volume is reduced in the volume reduction step to produce activated carbon.

18. The waste volume reduction processing system according to claim 9, the system comprising a hydrochloric acid recovery device of recovering hydrogen chloride gas produced in the volume reduction device as hydrochloric acid.

19. The waste volume reduction processing system according to claim 9, the system comprising a pulverizing device to pulverize the waste of which volume is reduced in the volume reduction device into a predetermined particle size and a screening device to remove unsuitable substances by sieving.

20. The waste volume reduction processing system according to claim 9, the system comprising an activating device to activate the carbonized material of the waste of which volume is reduced in the volume reduction step to produce activated carbon.
